(19) United States
(12) Patent Application Publication
(10) Pub. No.: US 2015/0095956 A1
(43) Pub. Date: Apr. 2, 2015

(54) ELECTRONIC DEVICE, COMPUTER PROGRAM PRODUCT, AND INFORMATION CONTROL METHOD

(71) Applicant: Kabushiki Kaisha Toshiba, Tokyo (JP)

(72) Inventor: Jun Kano, Ome-shi (JP)

(21) Appl. No.: 14/341,709

(22) Filed: Jul. 25, 2014

(30) Foreign Application Priority Data
Sep. 30, 2013 (JP) 2013-204527

(51) Int. Cl. H04N 21/436; H04N 21/4782; H04N 21/4363; H04N 21/64

(52) U.S. Cl. CPC H04N 21/43615; H04N 21/64; H04N 21/4782; H04N 21/4363
USPC 725/80

(57) ABSTRACT

According to one embodiment, an electronic device includes a detector, a receiver, and a controller. The detector is configured to detect, via a network, a receiver configured to receive a program in broadcasting and to acquire a location of interactive information configured to interact with the program based on information contained in the broadcasting. The receiver is configured to receive, from the receiver, first address information indicating the receiver. The controller is configured to provide, to a browser installed in the electronic device, second address information indicating a location of a web page implementing an interface to establish bidirectional connection, and to provide, to the browser, the first address information to establish connection with the receiver configured to be capable of transmitting the location of the interactive information by using the interface.

### CROSS-REFERENCE TO RELATED APPLICATIONS

This application is based upon and claims the benefit of priority from Japanese Patent Application No. 2013-204527, filed Sep. 30, 2013, the entire contents of which are incorporated herein by reference.

### FIELD

Embodiments described herein relate generally to an electronic device, a computer program product, and an information control method.

### BACKGROUND

Recently, smartphones and tables have been widely spread, and as a result, many users use their smartphones or tablets while watching broadcast programs. Following this trend, there has been developed a technology to display, on smartphones and tablets, information interacting with programs that the users are watching.

As a target for displaying information interacting with programs, web browsers have been considered. However, web browsers in general are not intended to interact with broadcast programs. Thus, the general web browsers do not automatically acquire information interacting with the broadcast programs. Accordingly, users need to input URLs directly in the web browsers so that the web browsers interact with the programs.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating an example of a network environment according to an embodiment;

FIG. 2 is an exemplary block diagram illustrating configurations of a broadcast receiver and a tablet in the embodiment;

FIG. 3 is an exemplary flowchart illustrating a processing of detecting the broadcast receiver by the tablet in the embodiment;

FIG. 4 is an exemplary flowchart illustrating a processing of displaying a program interaction content on a terminal HTML browser of the tablet in the embodiment;

FIG. 5 is an exemplary diagram illustrating an example of screen transition on the tablet until an HTML application interacting with a program is displayed, in the embodiment; and

FIG. 6 is an exemplary flowchart illustrating an overall processing in the broadcast receiver in the embodiment.

### DETAILED DESCRIPTION

In general, according to one embodiment, an electronic device comprises a detector, a receiver, and a controller. The detector is configured to detect, via a network, a receiver configured to receive a program in broadcasting and to acquire a location of interactive information configured to interact with the program based on information contained in the broadcasting. The receiver is configured to receive, from the receiver, first address information indicating the receiver. The controller is configured to provide, to a browser installed in the electronic device, second address information indicating a location of a web page implementing an interface to establish bidirectional connection, and to provide, to the browser, the first address information to establish connection with the receiver configured to be capable of transmitting the location of the interactive information by using the interface.

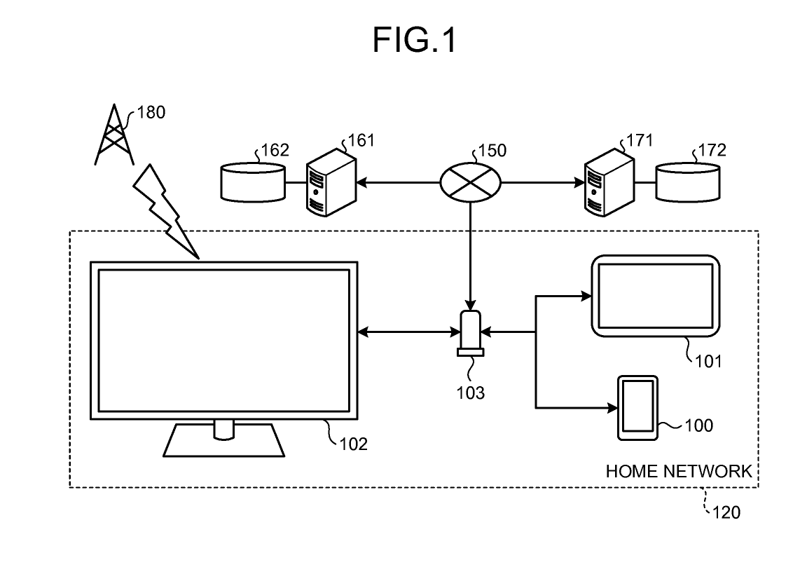

FIG. 1 is a diagram illustrating an example of a network environment according to an embodiment. In the network environment illustrated in FIG. 1, a smartphone 100, a tablet 101, a broadcast receiver 102, and a router 103 are disposed in a home (residential) network 120.

In the network environment illustrated in FIG. 1, the home network 120 is connected to an external network via a public communication line 150 to which a program interaction content server 161 and a start-up content server 171 are connected.

A broadcast station 180 provides, for example, a program in broadcasting. The broadcasting that the broadcast station 180 broadcasts also contains, other than the program, information such as a URL of a content interacting with the program. In the present embodiment, information contained in broadcasting is not limited to a URL of a content interacting with a program, but may be the content interacting with a program. Information contained in the broadcasting may only be information that directly or indirectly interacts with a program.

The program interaction content server 161 is provided by the broadcast station 180 providing programs, and is connected to a content storage device 162. The content storage device 162 stores therein, for example, contents (HTML applications) interacting with programs.

The start-up content server 171 is provided by, for example, a provider of mobile terminals so that the mobile terminals can interact with programs, and is connected to a start-up content storage device 172. The start-up content storage device 172 stores therein a start-up content (start-up HTML application) that enables a common web browser to interact with a program.

The broadcast receiver 102 is provided with an antenna (not illustrated), and performs operations such as displaying and storing therein a program contained in the broadcasting received via the antenna.

The broadcast receiver 102 transmits and receives data to and from, for example, the program interaction content server 161 via the public communication line 150. This allows the broadcast receiver 102 to access a content (HTML application) interacting with a program on the basis of a URL extracted from the broadcasting.

Although the embodiment describes an HTML application as an example of a content (program interaction content) interacting with a program, the content is not limited to the HTML application. The content interacting with a program may only be a content or a software application that can be displayed while interacting with a program.

In the present embodiment, there are two types of program interaction contents (HTML applications). One is a program interaction content that is displayed on the broadcast receiver 102, and the other one is a program interaction content that is displayed on mobile terminals such as the smartphone 100 and the tablet 101.

The broadcast receiver 102 accesses a program interaction content from a URL extracted from the broadcasting. The broadcast receiver 102 can transmit and receive information to and from the smartphone 100 and the tablet 101 via the router 103.

The smartphone 100 and the tablet 101 can connect to the broadcast receiver 102 in a wired or wireless manner via the router 103. The smartphone 100 and the tablet 101 may have mobile communication functionality such as third generation (3G) communication.

The smartphone 100 and the tablet 101 access a program interaction content using an interaction application to be described later that interacts with the broadcast receiver 102.

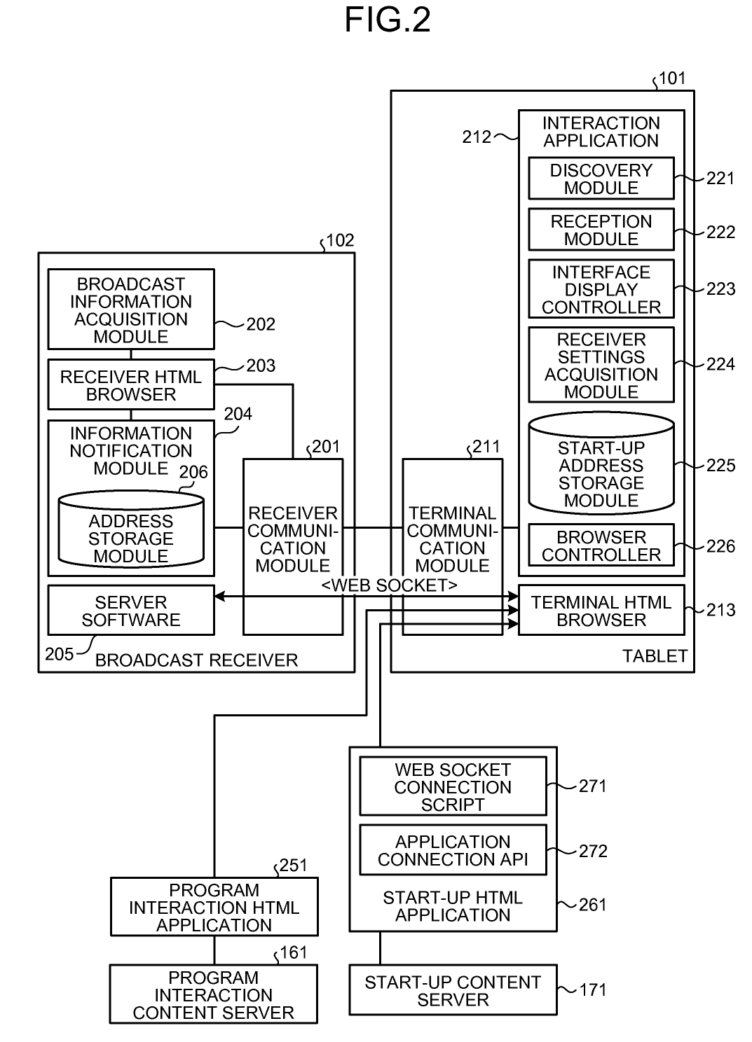

FIG. 2 is a block diagram illustrating configurations of the broadcast receiver 102 and the tablet 101 according to the embodiment. In the embodiment, the smartphone 100 has the same configuration as that of the tablet 101, thus the description thereof is omitted.

The broadcast receiver 102 illustrated in FIG. 2 comprises a receiver communication module 201, a broadcast information acquisition module 202, a receiver HTML browser 203, an information notification module 204, and server software 205.

The receiver communication module 201 is an interface for communicating with other apparatuses (such as the smartphone 100 and the tablet 101).

The broadcast information acquisition module 202 acquires, from the received broadcasting, information relevant to a content to be displayed. The broadcast information acquisition module 202 according to the embodiment acquires, from the received broadcasting, a URL of an HTML application interacting with a program provided in the broadcasting, as information relevant to the content to be displayed. In the embodiment, information acquired from the broadcasting is not limited to a URL, but may be an HTML application interacting with a program.

The receiver HTML browser 203 displays various types of contents such as HTML applications. It displays, for example, a content (HTML application) interacting with a program currently on the air on the basis of information (URL) acquired by the broadcast information acquisition module 202. The receiver HTML browser 203 may display the content by superimposing the content on the program currently on the air.

The present embodiment does not limit how to or where to acquire a URL of a program interaction content to be displayed on mobile terminals. The URL, for example, may be extracted from broadcasting, or may be acquired from an HTML application displayed on the receiver HTML browser 203. For example, when the URL is extracted from broadcasting, the broadcast receiver 102 receives broadcasting in which a URL of a program interaction content to be displayed on the broadcast receiver 102 and the URL of a program interaction content to be displayed on mobile terminals are contained. The URL of a program interaction content for the broadcast receiver 102 contains an identifier indicating that the content is displayed on receivers (the broadcast receiver 102), and the URL of a program interaction content for mobile terminals contains an identifier indicating that the content is displayed on mobile terminals (the smartphone 100 and the tablet 101). Based on the identifiers, the broadcast receiver 102 displays a program interaction content for receivers, and transmits the URL of a program interaction content for mobile terminals to the tablet 101. Later described is how to acquire the URL of a program interaction content displayed on mobile terminals from an HTML application.

The information notification module 204 stores a URL, acquired from broadcasting or through communication, of a program interaction content for mobile terminals such as the smartphone 100 and the tablet 101 in an address storage module 206. Upon receipt of a request from a mobile terminal (such as the smartphone 100 or the tablet 101), the information notification module 204 notifies the mobile terminal (such as the smartphone 100 or the tablet 101) of a URL stored in the address storage module 206 in response to the request.

For example, when the broadcast station 180 starts broadcasting providing a program intended to interact with mobile terminals (such as the smartphone 100 and the tablet 101), the broadcast receiver 102 first receives the broadcasting. The broadcast receiver 102 then extracts, from the received broadcasting, a URL of a content (HTML application), for the broadcast receiver 102, interacting with the program, and accesses the URL. The receiver HTML browser 203 acquires and interprets the content (HTML application), for the broadcast receiver 102, interacting with the program, and displays and controls the content.

When the content for the broadcast receiver 102, displayed on the receiver HTML browser 203, interacting with the program contains a URL of a content interacting with mobile terminals (such as the smartphone 100 and the tablet 101), the information notification module 204 stores the URL of a content interacting with mobile terminals (such as the smartphone 100 and the tablet 101) in the address storage module 206. When the broadcast receiver 102 acquires an interaction content (HTML application) for mobile terminals from broadcasting, the broadcast receiver 102 may assign a URL to the interaction content and save, and manage the interaction content under the server software 205, and may store the URL that the broadcast receiver 102 has assigned in the address storage module 206.

When the broadcast receiver 102 receives an interaction request from a mobile terminal (such as the smartphone 100 or the tablet 101), the information notification module 204 transmits the URL stored in the address storage module 206 to the mobile terminal (such as the smartphone 100 or the tablet 101).

In the present embodiment, the server software 205 of the broadcast receiver 102 and a terminal HTML browser 213 of a mobile terminal (such as the smartphone 100 or the tablet 101) maintain connection over which bidirectional communication is performed. This eliminates the load of establishing connection every time the broadcast receiver 102 and the mobile terminal communicate information to interact with a program.

The server software 205 provides a service for transmitting and receiving data between, for example, the terminal HTML browser 213 of a mobile terminal (such as the smartphone 100 or the tablet 101) and the receiver HTML browser 203 of the broadcast receiver 102. Upon receipt of a connection request from the mobile terminal, the server software 205 establishes connection between the receiver HTML browser 203 and the terminal HTML browser 213 of the mobile terminal so that the browsers can transmit and receive data therebetween.

When the receiver HTML browser 203 or the information notification module 204, and the terminal HTML browser 213 of a mobile terminal perform bidirectional communication to interact with a program, a communication path capable of high-speed communication with a rapid response time is required depending on a service.

Moreover, it is difficult for a common HTML browser to directly perform socket communication over, for example, TCP or UDP, and the common HTML browser does not respond rapidly in bidirectional communication when an operation such as polling on HTTP is performed.

In the present embodiment, the server software 205 implements WebSocket to establish connection in order to achieve high-speed communication with a rapid response time. In the present embodiment, the server software 205 functions as a WebSocket server, and the receiver HTML browser 203 and the terminal HTML browser 213 of mobile terminals (such as the smartphone 100 and the tablet 101) function as WebSocket clients.

The present embodiment is not limited to use WebSocket to establish connection and perform communication. When high-speed communication with a rapid response time is not required, the receiver HTML browser 203 of the broadcast receiver 102 and the terminal HTML browser 213 of mobile terminals (such as the smartphone 100 and the tablet 101) may perform polling on HTTP to communicate with each other by using an HTTP server as the server software 205.

The information notification module 204 or the receiver HTML browser 203 of the broadcast receiver 102, and the terminal HTML browser 213 of the mobile terminals can communicate data bidirectionally in real time by maintaining the connection as described above. This allows the broadcast receiver 102 to control a program interaction content displayed on the terminal HTML browser 213 of the mobile terminals in real time.

The tablet 101 comprises a terminal communication module 211, an interaction application 212, and the terminal HTML browser 213.

The terminal communication module 211 serves as an interface to communicate with other devices (such as the broadcast receiver 102).

The terminal HTML browser 213 displays thereon various contents such as an HTML application.

The terminal HTML browser 213 may be any web browser commonly used. When such a common web browser displays information, it needs to communicate with a provider of the information, but common web browsers do not have a function to communicate with the provider automatically. In other words, common web browsers rarely have a function to automatically detect a service provided by the broadcast receiver 102 to establish connection. Thus, in a conventional technology, a user of a mobile terminal needs to acquire an IP address or a URL and input the IP address or the URL in the mobile terminal via an interface.

In the present embodiment, the interaction application 212 provided in the tablet 101 asks the broadcast receiver 102 whether a service for mobile terminals to interact with a program is available in the broadcast receiver 102, and transmits and receives information necessary to establish connection with the broadcast receiver 102. When obtaining all the necessary information, the interaction application 212 requests the terminal HTML browser 213 to start up and delivers the information thereto. Thus, the terminal HTML browser 213 does not need to collect information necessary to establish connection with the broadcast receiver 102, that is, does not need to implement any specific application for this purpose, so that the terminal HTML browser 213 can interact with a program displayed on the broadcast receiver 102.

The interaction application 212 comprises a detector 221, a receiver 222, an interface display controller 223, a receiver settings acquisition module 224, a start-up address storage module 225, and a browser controller 226. When executed, the interaction application 212 collects information necessary for the terminal HTML browser 213 to display a program interaction content that interacts with mobile terminals, and delivers the necessary information to the terminal HTML browser 213. The interaction application 212 may not be an application dedicated for this purpose, but may be, for example, a remote-control application that operates the broadcast receiver 102.

The detector 221 discovers a device (such as the broadcast receiver 102) from which the tablet 101 can acquire information (such as a URL) relevant to a program interaction content that interacts with a program provided in broadcasting.

In the present embodiment, the detector 221 discovers devices in the home network 120 when a user executes the interaction application 212 to display a program interaction content on the tablet 101.

The receiver 222 receives, from the broadcast receiver 102, identification information (such as an IP address) necessary for the tablet 101 to connect to the broadcast receiver 102.

The receiver settings acquisition module 224 transmits and receives, through the terminal communication module 211, data to and from the broadcast receiver 102 that is specified by the received identification information to acquire information such as information on service availability in the broadcast receiver 102. The information on service availability is, for example, information as to whether the broadcast receiver 102 can provide the tablet 101 with information such as a URL of a program interaction content for mobile terminals, and a protocol for establishing connection with the broadcast receiver 102. The interaction application 212 stores therein identification information (such as an IP address) on a device (such as the broadcast receiver 102) that is determined to be a device through which the tablet 101 can interact with a program.

The interface display controller 223 is a graphical user interface used to display a program interaction application. The interface display controller 223 may be provided with an interface used as a remote control to operate the broadcast receiver 102.

The start-up address storage module 225 stores therein in advance a URL of the start-up content server 171 that provides a start-up HTML application 261.

The start-up HTML application 261 is an HTML application that the terminal HTML browser 213 displays thereon to interact with a program when starting up. The start-up HTML application 261 comprises a WebSocket connection script 271 (an interface for a WebSocket connection) necessary for the tablet 101 to establish connection with the broadcast receiver 102 using WebSocket, and an application connection API 272 that is a library necessary to execute a program interaction HTML application 251.

The browser controller 226 delivers, to the terminal HTML browser 213, a URL indicating a location of the start-up HTML application 261 that implements an interface (the WebSocket connection script 271) used to establish connection (a WebSocket connection, in the embodiment) for bidirectional communication. The browser controller 226 also delivers, to the terminal HTML browser 213, identification information (such as an IP address) on the broadcast receiver 102 that can transmit a program interaction HTML application for mobile terminals.

The terminal HTML browser 213 first reads the start-up HTML application 261 that implements an interface for establishing connection using WebSocket, and then implements the interface (the WebSocket connection script 271). This allows the terminal HTML browser 213 to establish connection, using WebSocket, with the information notification module 204 and the receiver HTML browser 203 of the broadcast receiver 102 via the server software 205.

The terminal HTML browser 213 receives the URL of the program interaction HTML application 251 from the information notification module 204 of the broadcast receiver 102. This URL indicates the program interaction content server 161 that provides the program interaction HTML application 251. The terminal HTML browser 213 accesses the received URL to display a program interaction content (HTML application) for mobile terminals. Thus, the terminal HTML browser 213 can display thereon a program interaction content (HTML application) for mobile terminals.

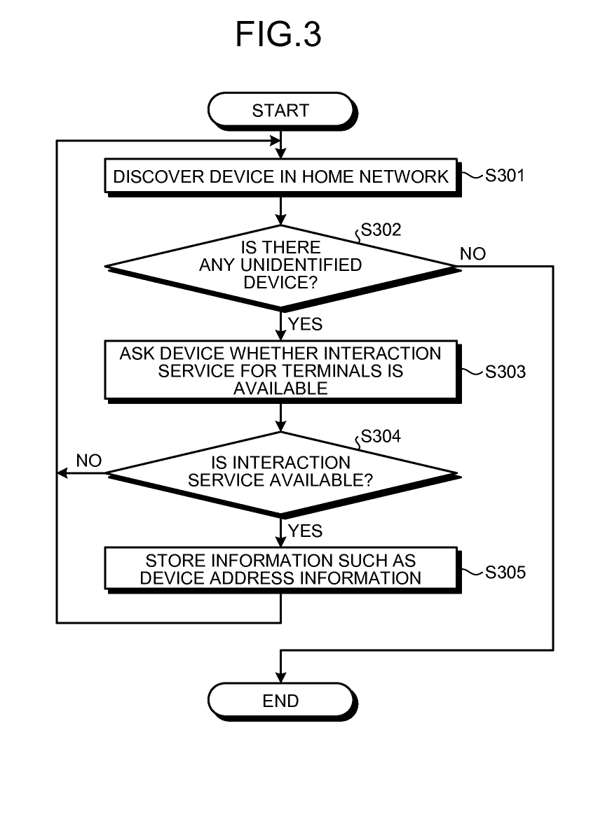

Next, described is a procedure for discovering the broadcast receiver 102 by the interaction application 212 of the tablet 101 according to the embodiment. FIG. 3 is a flowchart illustrating the procedure of the above-described processing performed by the tablet 101 in the embodiment. The smartphone 100 also performs the same processing as that performed by the tablet 101, thus the description thereof is omitted.

First, the detector 221 of the interaction application 212 discovers devices that can connect to the tablet 101 (S301) in the home network 120 to which the tablet 101 is connected. To discover these devices, the simple service discovery protocol (SSDP) in universal plug and play (UPnP) may be used.

When discovering the devices, the detector 221 determines whether there is any unidentified device among the devices (S302). When determining that there is an unidentified apparatus (Yes at S302), the receiver settings acquisition module 224 communicates with the unidentified device thus discovered, and asks the device whether a terminal interaction service is available in the device (S303). The receiver settings acquisition module 224 uses settings acquired from the unidentified device to determine whether the terminal interaction service is available in the unidentified device (S304). When determining that the terminal interaction service is not available in the unidentified device (No at S304), the process returns to S301.

When determining that the terminal interaction service is available in the unidentified device (Yes at S304), the receiver settings acquisition module 224 acquires, from the unidentified device (such as the broadcast receiver 102), address information and information such as a protocol necessary to establish connection with the device, and stores, for example in an SSD (not illustrated), the address information (IP address) and other information on the device thus acquired (S305). After that, the process returns to S301.

When the detector 221 determines that there is no unidentified device among the devices discovered by the detector 221, that is, determines that all the devices have been identified (No at S302), the process is completed. The processing illustrated in FIG. 3 may be performed upon every execution of the interaction application 212, or the information may be updated on a regular basis, or updated by an operation of a user.

With the processing illustrated in FIG. 3, the tablet 101 can store therein information such as the IP address of the broadcast receiver 102. After the storage of the information, the user operates a screen displayed by the interface display controller 223 of the tablet 101 to display a program interaction content.

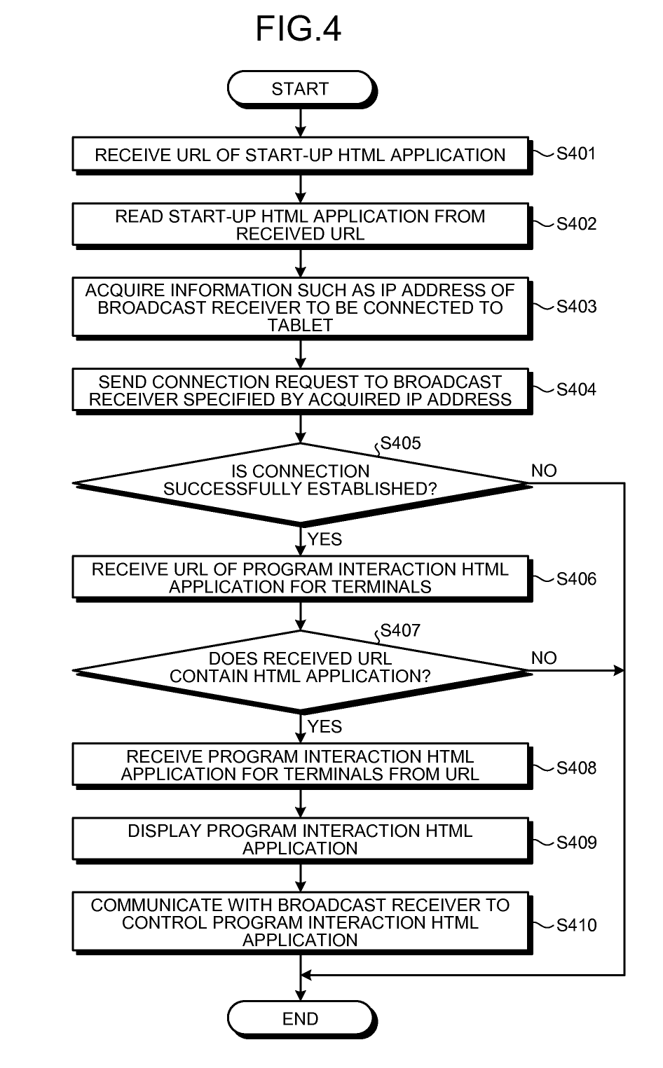

Next, described is a procedure for displaying a program interaction content by the terminal HTML browser 213 of the tablet 101 according to the embodiment. FIG. 4 is a flowchart illustrating the procedure of the above-described processing performed by the terminal HTML browser 213 of the tablet 101 in the embodiment. The smartphone 100 also performs the same procedure as that performed by the tablet 101, thus the description thereof is omitted.

It is assumed that the interface display controller 223 displays an operating screen before the terminal HTML browser 213 starts the process of displaying a program interaction content. When the user pushes, for example, a start button on the operating screen, the interaction application 212 delivers the URL of the start-up HTML application 261 to the terminal HTML browser 213, and the process is started.

First, the terminal HTML browser 213 receives, from the interaction application 212, the URL of the start-up content server 171 that provides the start-up HTML application 261 (S401). This URL is stored in the start-up address storage module 225, and is a URL of an HTML application that the terminal HTML browser 213 first reads when starting up, irrespective of where the terminal HTML browser 213 acquires a program interaction content.

Then, the terminal HTML browser 213 reads the start-up HTML application 261 from the URL thus received (S402). With this process, the terminal HTML browser 213 acquires an interface used to establish connection with the broadcast receiver 102 using WebSocket, and a library used to execute a program interaction HTML application.

The terminal HTML browser 213 acquires, from the interaction application 212, information such as the IP address of the broadcast receiver 102 to which the tablet 101 is to be connected (S403).

The terminal HTML browser 213 sends, by using the interface for a WebSocket connection implemented by the start-up HTML application 261, a connection request to the server software 205 of the broadcast receiver 102 specified by the IP address acquired (S404). The terminal HTML browser 213 determines whether it has successfully established connection with the server software 205 of the broadcast receiver 102 using WebSocket (S405). When the terminal HTML browser 213 determines that it has failed to establish connection with the server software 205 (No at S405), the process is terminated.

When the terminal HTML browser 213 determines that it has successfully established connection with the server software 205 of the broadcast receiver 102 using WebSocket (Yes at S405), the terminal HTML browser 213 sends an inquiry to the broadcast receiver 102 whether the information notification module 204 has a URL of a content (HTML application) for mobile terminals in accordance with a script described in the start-up HTML application 261. In response to the inquiry, the terminal HTML browser 213 receives, from the information notification module 204 of the broadcast receiver 102, information, such as the URL of the program interaction HTML application 251 for mobile terminals, necessary to display a content interacting with a program (S406). The URL received from the information notification module 204 is assumed to be the URL of the program interaction HTML application 251 stored in the program interaction content server 161. When the broadcast receiver 102 acquires and stores therein the program interaction HTML application 251 for mobile terminals, the URL received from the information notification module 204 may be a URL indicating the location of the program interaction HTML application 251 for mobile terminals in the broadcast receiver 102. The terminal HTML browser 213 sets therein the received URL in accordance with the script described in the start-up HTML application 261.

Although the present embodiment describes an example in which the terminal HTML browser 213 requests a URL from the broadcast receiver 102, the broadcast receiver 102 may transmit, to a mobile terminal (such as the tablet 101), a URL that has already been set in the broadcast receiver 102 by, for example, a response, when connection is established with the mobile terminal.

The terminal HTML browser 213 determines whether the received URL contains an HTML application (S407). When determining that the received URL contains no HTML application (No at S407), the terminal HTML browser 213 terminates the process while maintaining display of the start-up HTML application 261 on the terminal HTML browser 213. The terminal HTML browser 213 may otherwise be terminated and the tablet 101 may display a screen of the interaction application 212.

When determining that the received URL contains an HTML application (Yes at S407), the terminal HTML browser 213 receives the program interaction HTML application 251 for mobile terminals from the received URL (S408).

The terminal HTML browser 213 displays thereon the program interaction HTML application 251 thus received (S409). At this time, the terminal HTML browser 213 may change settings such as a browser location setting to display the program interaction HTML application 251. The terminal HTML browser 213 may use the application connection API 272 implemented by the start-up HTML application 261 to display the program interaction HTML application 251. The application connection API may be created using, for example, JavaScript (registered trademark).

When the terminal HTML browser 213 displays thereon an HTML application that interacts with mobile terminals, the broadcast receiver 102 gives, in the same manner as in the procedure for displaying the start-up HTML application 261 described above, the terminal HTML browser 213 information necessary to communicate with the broadcast receiver 102 as a query, so that the terminal HTML browser 213 can keep connected with the broadcast receiver 102 using WebSocket. When a new URL of an HTML application that interacts with mobile terminals is set, the terminal HTML browser 213 acquires the new URL through the connection using WebSocket and displays the HTML application indicated by the URL.

The terminal HTML browser 213 communicates with the broadcast receiver 102 connected thereto using WebSocket to control the program interaction HTML application 251 so that the application interacts with a program in accordance with information transmitted from the broadcast receiver 102 (S410).

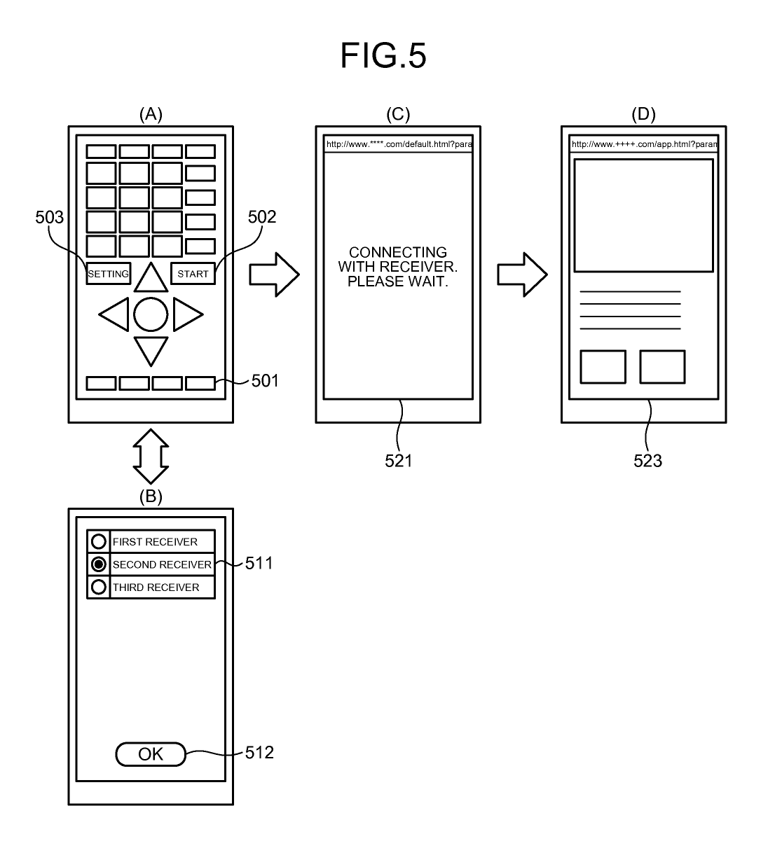

Next, described is screen transition on the tablet 101 until an HTML application interacting with a program is displayed. FIG. 5 is a diagram illustrating an example of screen transition on the tablet 101 until an HTML application interacting with a program is displayed. The smartphone 100 performs the same processing as that performed by the tablet 101 on the screen transition, thus the description thereof is omitted.

As illustrated in (A) of FIG. 5, when a user executes the interaction application 212 of the tablet 101, the interface display controller 223 of the interaction application 212 displays a screen 501 that is a graphical user interface also serving as a remote control of the broadcast receiver 102. The screen 501 illustrated in (A) of FIG. 5 displays a start button 502 for program interaction, and a setting button 503 for selecting a broadcast receiver to which the tablet 101 is to be connected. The interaction application 212 displays the screen illustrated in (A) of FIG. 5, and at the same time, performs other processing such as discovery of apparatuses as described above. The interaction application 212 may change a display mode of the start button 502 depending on the availability of interactive function. Specifically, when the terminal HTML browser 213 fails to determine, at S406 in FIG. 4, that the information notification module 204 of the broadcast receiver 102 has a URL of a content (HTML application) for mobile terminals, the interaction application 212 may display the start button 502 in gray, and when the terminal HTML browser 213 determines that the information notification module 204 has a URL of a content (HTML application) for mobile terminals, the interaction application 212 may display the start button 502 in a highlighted or a flashing mode. (B) of FIG. 5 is a screen example for selecting a broadcast receiver to which the tablet 101 is to be connected. The interface display controller 223 displays the screen example when receiving a pushing operation on the setting button 503 illustrated in (A) of FIG. 5 by the user. On the screen example of (B) of FIG. 5, the interface display controller 223 displays a list 511 of apparatuses discovered. The user selects a broadcast receiver to which the tablet 101 is to be connected from the list 511 of apparatuses discovered, and pushes an OK button 512. This sets the broadcast receiver thus selected as an apparatus to which the tablet 101 is to be connected to interact with a program, and the screen illustrated in (A) of FIG. 5 is redisplayed.

When the user watches a broadcast program to find that the program has a program interaction content for mobile terminals, and wants to implement the content, the user pushes the start button 502 on the screen 501 illustrated in the (A) of FIG. 5. Although the present embodiment describes an example in which buttons are used to operate the screen transition, the embodiment is not limited to this. The user may select “display of program interaction content” from a menu, or may perform any other operation (such as shaking the mobile terminal) to cause the tablet 101 to start displaying and controlling a program interaction content. When a broadcast receiver to which the tablet 101 is to be connected is set in advance, the tablet 101 may perform start-up processing of a program interaction content immediately after the execution of the interaction application 212 without receiving a pushing operation on the start button 502 by the user.

(C) of FIG. 5 illustrates a screen example 521 that is a screen example of the start-up HTML application 261 that the terminal HTML browser 213 displays thereon upon receipt of a pushing operation by the user on the start button 502 illustrated in (A) of FIG. 5. The screen example illustrated in (C) of FIG. 5 is a screen example of an HTML application read from a URL stored in the start-up address storage module 225. The terminal HTML browser 213 establishes connection with the server software 205 of the broadcast receiver 102 while displaying the screen example illustrated in (C) of FIG. 5. When the terminal HTML browser 213 acquires the URL of the program interaction HTML application 251 for mobile terminals from the broadcast receiver 102, the terminal HTML browser 213 displays the screen illustrated in (D) of FIG. 5.

(D) of FIG. 5 illustrates a screen example 523 that is a screen example of the program interaction HTML application 251 displayed on the terminal HTML browser 213. The program interaction HTML application 251 displayed on the terminal HTML browser 213 can interact with a program in real time by transmitting and receiving information to and from the broadcast receiver 102 using WebSocket.

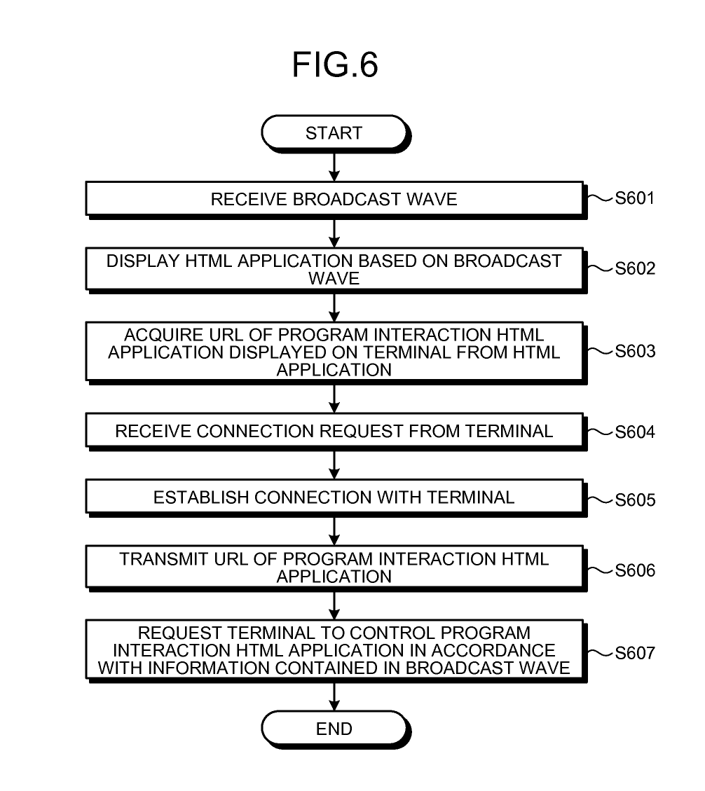

Next, described is the overall processing performed by the broadcast receiver 102 according to the embodiment. FIG. 6 is a flowchart illustrating the procedure of the above-described processing performed by the broadcast receiver 102 in the embodiment.

First, the broadcast information acquisition module 202 receives broadcasting (S601). Then, the receiver HTML browser 203 displays an HTML application on the basis of the received broadcasting (S602). The HTML application may be displayed by being superimposed on a program provided in the broadcasting.

The information notification module 204 acquires the URL of the program interaction HTML application 251 to be displayed on a mobile terminal from the HTML application displayed on the receiver HTML browser 203, and stores the URL in the address storage module 206 (S603).

The server software 205 receives a connection request form a mobile terminal (S604). Upon receipt of the request, the server software 205 establishes connection with the mobile terminal using WebSocket (S605).

In response to a request from the mobile terminal, the information notification module 204 transmits the URL of the program interaction HTML application 251 stored in the address storage module 206 to the mobile terminal (S606).

The information notification module 204 requests the mobile terminal, with which the broadcast receiver 102 is connected, to control the program interaction HTML application in accordance with information contained in the broadcasting received by the broadcast information acquisition module 202 (S607).

Although the present embodiment describes an example in which a mobile terminal specifies an apparatus to which the mobile terminal is to be connected by using a URL or an IP address, information specifying the apparatus is not limited to the URL or the IP address. Other information such as a domain name may also be used.

The interaction application 212 provided in a mobile terminal (such as the smartphone 100 and the tablet 101) in the embodiment performs processing such as storing the URL of the start-up HTML application 261 and discovering the broadcast receiver 102. This enables the terminal HTML browser 213 to display thereon information such as the program interaction HTML application 251 without receiving an operation from the user such as directly inputting a URL, even when the terminal HTML browser 213 is a common web browser. This facilitates interaction with a program even when a common web browser is used.

The mobile terminal in the embodiment is designed to use a common web browser, thereby reducing cost to make the mobile terminal interactive with a program while maintaining a simple process to establish connection. The mobile terminal in the embodiment can use an application such as a WebSocket client installed in advance in the web browser to achieve high-speed communication with rapid response time, thereby providing the user with a service with higher performance in bidirectional communication.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a detector configured to detect, via a network, a receiver configured to receive a program in broadcasting and to acquire a location of interactive information configured to interact with the program based on information contained in the broadcasting;
a receiver configured to receive, from the receiver, first address information indicating the receiver; and
a controller configured to provide, to a browser installed in the electronic device, second address information indicating a location of a web page implementing an interface to establish bidirectional connection, and to provide, to the browser, the first address information to establish connection with the receiver configured to be capable of transmitting the location of the interactive information by using the interface.

2. The electronic device of claim 1, further comprising a browser configured to establish connection with the receiver indicated by the first address information by using the interface implemented by the web page acquired from the second address information, and configured to receive third address information indicating the location of the interactive information.

3. The electronic device of claim 2, wherein the browser is further configured to receive the interactive information from the third address information, and is configured to display thereon the interactive information.

4. The electronic device of claim 2, wherein the web page acquired by the browser implements a library for displaying the interactive information.

5. A computer program product having a non-transitory computer readable medium including programmed instructions, wherein the instructions, when executed by a computer, cause the computer to perform:
detecting, via a network, a receiver configured to receive a program in broadcasting and to acquire a location of interactive information configured to interact with the program based on information contained in the broadcasting;
receiving, from the receiver, first address information indicating the receiver;
providing, to a browser installed in the computer, second address information indicating a location of a web page implementing an interface to establish bidirectional connection, and providing, to the browser, the first address information to establish connection with the receiver configured to be capable of transmitting the location of the interactive information by using the interface.

6. An information control method performed by an electronic device, the information control method comprising:
detecting, via a network, a receiver configured to receive a program in broadcasting and to acquire a location of interactive information configured to interact with the program based on information contained in the broadcasting;
receiving, from the receiver, first address information indicating the receiver;
providing, to a browser installed in the electronic device, second address information indicating a location of a web page implementing an interface to establish bidirectional connection, and providing, to the browser, the first address information to establish connection with the receiver configured to be capable of transmitting the location of the interactive information by using the interface.
